(19) United States
(12) Patent Application Publication
(10) Pub. No.: US 2024/0392511 A1
(43) Pub. Date: Nov. 28, 2024

(54) BARRIER BOARD AND A METHOD TO PRODUCE IT

(71) Applicant: Abnor Oy, Kalkkiranta (FI)

(72) Inventors: Björn-Erik FORSS, Kalkkiranta (FI); Bo AHLSKOG, Tampere (FI)

(73) Assignee: Abnor Oy, Kalkkiranta (FI)

(21) Appl. No.: 18/704,596

(22) PCT Filed: Nov. 3, 2022
(86) PCT No.: PCT/FI2022/050717

§ 371 Date: Apr. 25, 2024

(30) Foreign Application Priority Data
Nov. 11, 2021 (FI) 20216159

(51) Int. Cl. D21H 27/38; B32B 29/00; B32B 29/08; D21H 11/04; D21H 19/12; D21H 27/10; D21H 27/40

(52) U.S. Cl. CPC D21H 27/38; B32B 29/005; B32B 29/08; D21H 11/04; D21H 19/12; D21H 27/10; D21H 27/40; B32B 2250/26; B32B 2255/12; B32B 2255/26; B32B 2307/718; B32B 2307/7265; B32B 2439/70

(57) ABSTRACT

A barrier board has a first layer and is intended for foodstuff packaging material. The main raw material of the first layer is chemical pulp, the SR grinding value of which is over 50 and the weight per square meter is over 90 g. One application is where there are at least two layers and the main raw material of the first layer is chemical pulp, the grinding SR value of the chemical pulp is over 50 and the main raw material of the second layer is chemical pulp, mechanical pulp, CTMP mass or semi-chemical pulp. When the raw material is chemical pulp, its grinding SR value is over 35. If the raw material condition is fulfilled the grinding SR values of the first layer and the second layer are the other way around than what has been defined before.

### FIELD

The aspects of the disclosed embodiments are directed to a barrier board that consists of at least the first layer and that is intended for packing foodstuffs.

The scope of the usage of the aspects of the disclosed embodiments is the packaging of the foodstuffs and its meaning is to replace as much as possible the barrier boards in the market consisting plastic for this purpose as well as plastic materials, paper/board and plastic combination materials and packing materials containing aluminum, to replace all these with completely plastic free and sustainably recyclable material. With the help of the aspects of the disclosed embodiments, it is the intention to put to use the characteristics of the coniferous and birchen chemical pulps so that nature and climate polluting substances can be avoided, e.g. before mentioned plastic used as a barrier layer of a wood-based packaging material or as a part of it. With the help of the aspects of the disclosed embodiments, it is possible to reduce the amount of plastic, glass, and metal packages use in the packing of the foodstuffs.

Advantageous usages of the aspects of the disclosed embodiments are such packages of the solid, semi-solid, or liquid foodstuffs where the transfer of water, other liquid, fat, odor, or taste from the foodstuff to the environment is prevented or to prevent the transfer of harmful substances from the packaging material or the environment to the foodstuff. The barrier layer or the protection layer of a board package is needed especially when the foodstuff is moist, liquid, or fatty.

The word “barrier” when speaking of the packages for foodstuffs has become general also in the Finnish language so it is used in this document as it is or a part of a compound in this document.

The raw material chemical pulp of the barrier board according to the aspects of the disclosed embodiments is ordinary chemical pulp that can be defined in a known way by the measure scale of its fibers as follows: the length of the fibers is about 500-3000 μm and the diameter 15-40 μm. In the solutions according to the known technology the chemical pulp used is the mentioned ordinary chemical pulp and it is mentioned for the clarity that nano-chemical pulps like for instance micro fibrillated chemical pulp (MFC) that has the fiber length of about 1-10 μm and the diameter <0.1 μm are not suitable for the raw material of the barrier board according to the aspects of the disclosed embodiments.

### BACKGROUND

The barrier boards according to the known technology consist of one or more chemical pulp or mass layers and their back layer that is against the food stuff in the package, i.e. the inside layer, is coated with plastic (laminated). The most common plastic used in the coating is polyethylene (PE) but also polypropylene (PP) and polyethylene terephthalate (PET) are used.

As an example of the nowadays used foodstuff packages made of the PE laminated boards are for instance liquid packages, board cups, deep freeze food packages and ice cream packages. If the produced board liquid package is desired to be aseptic its barrier is made of plastic or aluminum layer and as aluminum cannot be allowed to be in direct contact with the liquid an additional layer of PE is still laminated upon the aluminum. As examples of this kind of packages the packages for juice and long-life milk can be mentioned.

One known method to pack foodstuff in a barrier package is to provide it with printing that conveys information and to pack it in two different materials, first in plastic, barrier paper, or aluminum (an example of the latest: a tin) and then upon it adapt paper or board on the surface of which there is the printing. As examples of these packages can be mentioned convenience food, deep freeze food, coffee, and muesli packages.

It is known that many of today's foodstuff packages are made of board of three layers where the surface layer has good printing properties the middle layer has good strength and folding properties and the back layer has sufficient barrier properties. The weight per sq meter of the middle layer is used to determine the total thickness of the board so that the characteristic stiffness of the board is obtained that in turn makes it possible to fold the board into a box etc.

The folding boxboard is a typical example of the three-layer construction of a board. In its all layers, virgin fiber is used: In the middle layer mechanical or semi-mechanical mass that is chemical pulp, semi-chemical pulp from chips and in the surface and back layers bleached chemical pulp. The surface is almost always coated so that the by producer/seller desired information can be printed on it. In the known technology, the barrier of a folding boxboard against the food stuffs is usually made by laminating PE plastic upon the back layer.

Another multi-layer board is solid board. In all its layers, bleached chemical pulp or unbleached (brown) chemical pulp is used and normally its surface layer is coated for printing. The solid board is used as it is for dry food stuff packaging, e.g. chocolate, but when a barrier is needed the back layer is coated with PE, PP, or PET plastic using the extrusion method.

Packaging board for liquids consists of chemical pulp (bleached or unbleached) but also semi-chemical pulp from chips (CTMP mass). Also, the barrier of this board is made by laminating the surface with PE plastic.

Recyclable fiber based WLC board is suitable for food stuff only as outer package. When it is in touch with the foodstuff its inside is laminated with PE plastic.

When producing board the chemical pulp as also all mechanical pulps and semi-mechanical pulps are ground with the intention to change the characteristics of the fiber better for the production of the mentioned product. In the grinding process the fibers are worked by grinding them in water. In the grinding process hydrogen bonds of fibers are cut and new bonds are formed to water molecules which lead to the swelling of fiber. This way, the surface of the fiber becomes larger and the swollen fibers bind better to each other in the wire. The quality of the grinding affects both the characteristics of the finished board and the handling of the mass in the machine. The grinding increases the durability of the chemical pulp-based layers but weakens their optical properties like opacity, gloss, and lightness. Additionally, too much grinding weakens the drain ability of the mass and thus the mass gets dry more slowly when producing board which means in practice higher consumption of energy in the board machine and the grinder. According to the known technology the grinding is optimized taking into account its known advantages and disadvantages. The degree of the grinding is described by the drain ability where the unit is Schopper-Riegler value or SR value. Today's folding boxboard and solid board degree of grind in its different layers are about 20-30 expressed with the SR values.

During the latest decades (since 1980) water-soluble polymer dispersions have been developed that can be used mixed with suitable coating mineral to coat board or paper. After drying this kind of coating forms a barrier that repels water and/or fat. This kind of board material is recyclable and compostable. In this way formed barrier surface is relatively thin (10-15 g sq m) and small holes or cracks can be formed in it during the production process or refining process. This causes that polymer dispersion-based barrier boards cannot be used in as demanding foodstuff packaging as for instance PE plastic coated board: the plastic layer (15-40 g sq m) material is so flexible that there does not usually form holes easily.

The Finnish Metsäboard is the biggest folding boxboard producer in Europe and in their Internet site www.metsaboard.com for instance their board products are presented.

The Swedish Holmen Iggesund produces solid board and laminates it with plastic. One can get to know the company's products and production in the Internet site www.iggesund.com

The weakest spots of the known foodstuff boards and their production are connected to the use of the fossil plastic. The plastic is seen to be disadvantageous and a raw material that harms nature also by the professionals of the board and package industry and the package users and one wants to get rid of it. The obstacle for this has been that there has not been in existence a sufficiently good environment friendly technique.

One disadvantage of the known technology can also be seen that the most common plastic used in the barrier board, polyethylene, is not suitable to be heated in the oven. This sets its own limitations for its use in the foodstuff packaging.

In the international patent publications WO 2015 036932 A1 and WO 2015 036930 A1 are presented solutions that are intended to solve the following problems in the fluid and food product board production of the company named Stora Enso Oyj: the company had a problem to acquire softwood pulp where as in hardwood pulp there was not the difficulty, additionally, the price of the softwood pulp was experienced in the company market situation too high so that the board made of it could not be made competitive and to protect the light barrier in the boards was challenging when trying to achieve saving in different ways.

The solution of the abovementioned publications for the before mentioned problems are based in the following matters: in the back ply of the board the long fiber softwood pulp be replaced totally with the short fiber hardwood pulp, in the before mentioned to be used unbleached so that the light barrier is secured, the before mentioned pulp to be used with a low fineness of grind (SR 34.8-37.1) to save the costs. The message of the publications is that using the before mentioned solutions a better barrier in relation to the known is not tried to get against humidity, fat, or oil but instead savings without going short of the quality of the light barrier when producing board for dry product packaging.

The meaning of the aspects of the disclosed embodiments is to bring about such a barrier board and a method to produce it that avoids the disadvantages of the known technology. It is characteristic for the solution according to the invention what has been presented in the independent claims.

### SUMMARY

The aspects of the disclosed embodiments have numerous advantages in relation to the known technology. In the foodstuff packing barrier board according to the aspects of the disclosed embodiments no fossil raw material is used, like for instance plastic. Its barrier layer is obtained from wood material and from none-fossil additives. Packing the foodstuffs in board is globally a huge branch of activity and as the barrier board can be produced totally from the raw materials of the sustainable development it is from its own part a quantum leap towards the fossil free world.

When comparing the aspects of the disclosed embodiments with the foodstuff packing of two materials consisting of plastic/barrier paper/aluminum and board it helps to save packing materials and improve their recyclability.

The plastic free foodstuff packages according to the aspects of the disclosed embodiments are suitable for heating for which purpose the PE laminated board boxes, cups, cans, etc. are not suitable. The barrier board according to the aspects of the disclosed embodiments does not release harmful substances, tastes or odors to the foodstuff during the heating.

The method to produce the barrier board according to the aspects of the disclosed embodiments makes it possible to take into use a before mentioned new environment friendly product.

### BRIEF DESCRIPTION OF THE DRAWINGS

The aspects of the disclosed embodiments is described more precisely in the enclosed drawings where

FIG. 1 shows a three-layer barrier board according to the aspects of the disclosed embodiments,

FIG. 2 shows a two-layer barrier board according to the aspects of the disclosed embodiments,

FIG. 3 shows a one-layer barrier board according to the aspects of the disclosed embodiments,

FIG. 4 shows an application of the three-layer solution of the aspects of the disclosed embodiments that is different from FIG. 1,

FIG. 5 shows a chart of a realization of the aspects of the disclosed embodiments,

FIG. 6 shows a chart about another realization of the aspects of the disclosed embodiments.

Next, special characteristics of the production method of the barrier board according to the aspects of the disclosed embodiments will be explained by referring to the before mentioned figures.

### DESCRIPTION OF THE DISCLOSED EMBODIMENTS

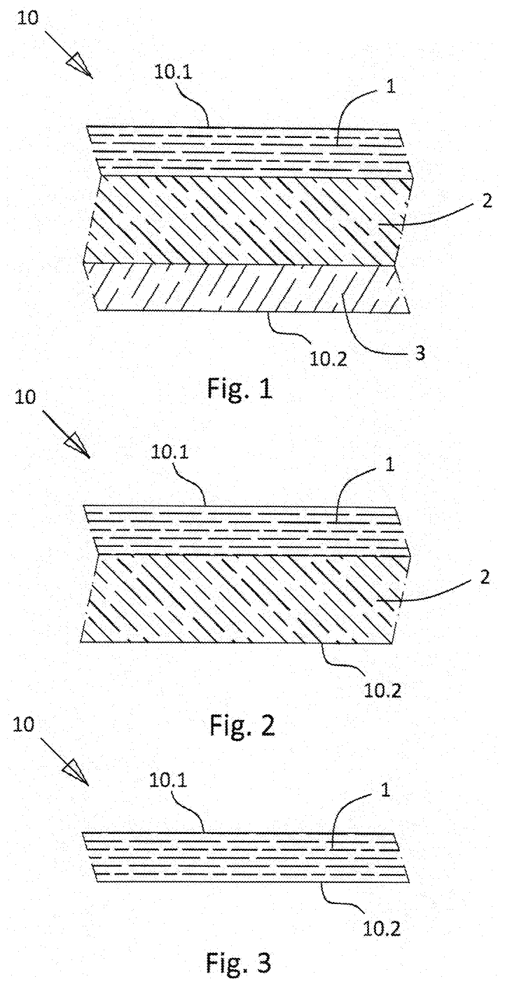

The barrier board 10 according to the aspects of the disclosed embodiments consists of one, two, or three layers (FIGS. 1-3). In its chemical pulp raw material production process, grinding having a mechanical influence on chemical pulp fiber without cutting it is used in such a way that at least one layer reaches barrier against water, oil, or fat or all these so that the board is suitable for foodstuff package.

The barrier board 10 according to the aspects of the disclosed embodiments is produced by a new way of aspects of the disclosed embodiments. In the production, advanced softwood and/or hardwood pulp is used. The tests have shown that the barrier qualities start to appear in the chemical pulp when its degree of grind gets over SR 40 and they get better as the degree of grind gets higher, with the birchen chemical pulp all the way up to SR 80. On the other hand, the web formation and drying of a thick and tight board get more difficult as the degree of grind rises over the ordinary (SR 30). The tests have shown that both the softwood and hardwood pulp barrier characteristics get better over SR 40 but more in the hardwood pulp than softwood pulp whereas the important characteristics like for instance the bending stiffness and the strength remain in the softwood pulp better than in the hardwood pulp over this mentioned limit.

According to the aspects of the disclosed embodiments the grinding of the chemical pulp is performed so that the bundles of fiber that form the chemical pulp can be gotten to come loose from each other and to fibrillate without the fibers to get cut and that the grinding has a mechanical influence on chemical pulp fibers. In the method according to the aspects of the disclosed embodiments the fibers stick to each other in such a way that the bonds between them retain also after the drying. This is a prerequisite for forming the barrier characteristics. In the present method, the grinding of the chemical pulp raw materials of the barrier board 10 is performed in two or more phases in itself according to the old technology in such a way that the degree of grind rises in each phase about SR 15-20. But because removing water from the chemical pulp film-strip of high degree of grind is more difficult than ordinary folding boxboard chemical pulp board film-strip it is performed by reducing the production speed of the board machine. This drawback can be accepted in this phase of the development because the product that is obtained with the method repays it in many ways.

In the different layers of the barrier board 10 according to the aspects of the disclosed embodiments hardwood pulp, softwood pulp, or a mixture of these chemical pulps can be used. The mixing ratios can be adapted favorable in each case.

Other characteristics of the method according to the aspects of the disclosed embodiments are the uses of certain additives in the chemical pulp. About these there will be dealt something in the next paragraphs.

It has been shown by tests that adding resin glue (ordinary commercial resin) to SR 60 ground softwood pulp and SR 75 ground hardwood pulp ameliorates their barrier characteristics for instance against water by 50% and against oil by 100%. The advantageous amount of this additive in the chemical pulp when talking about the mentioned barrier effect ameliorations is about 2-3% about the weight of the chemical pulp but also other amounts of the resin glue and lower degrees of grind can come into question. In the method according to the aspects of the disclosed embodiments the resin glue can be added to the barrier board 10 foodstuff side, that is back side, that is also called in this document the first layer 1 and to the middle layer, that is the second layer 2, chemical pulp. When it is question about a one-layer barrier board 10 the resin glue is added to its chemical pulp.

As an example of commercial fossil free resin glue, we can mention Solenis Corporation product Hi-pHase 40. This product is also produced in Finland.

In this document, the term “resin glue” means fossil free resin and in addition to what has been said before there are in the market also other resin products that can be used with the aspects of the disclosed embodiments.

It has also been shown by tests that adding also commercial product carboxyl methyl cellulose (CMC) into the before mentioned ground chemical pulps ameliorates their barrier properties against oil. In the tests that have been made the amount of CMC that was added to SR 60-75 chemical pulps was about 2% of the weight of the chemical pulp and the rise of the barrier property was about 30%. It has been possible to notice by the tests that one favorable amount of this additive in relation to the weight of the chemical pulp is depending on the desired barrier amelioration about 1-3% but also other CMC amounts and the degrees of grind of the chemical pulps can come into question. In the method according to the invention CMC can be added to the chemical pulps of first layer 1 or the first layer 1 and the second layer 2. When it is question about the one layer barrier board it can be added to its chemical pulp. The method according to the invention can be applied also so that no CMC is added to the chemical pulp of certain barrier board.

After the drying, it is possible to add to the back 10.1 and/or to the surface 10.2 of the three-layer barrier board 10 according to the aspects of the disclosed embodiments a coating of CMC, that is to process them with a CMC surface sizing to ameliorate the board technical properties and the first layer 1 barrier gets this way further better. This way processed food stuff board is suitable of its structural properties for today's boxes and pastry molds producing packing lines with small alterations to them. It is known that the process of a packing line includes at least printing the board and scoring and cutting it.

The before mentioned surface processing can be done for the barrier board 10 of three, two, or one layers.

The one-layer barrier board 10 according to the aspects of the disclosed embodiments can be in principle produced like the first layer 1 of the three-layer barrier board. The difference is different degree of grinding and weight per sq m and there will be told more of this later. These products are suitable for the fresh foodstuff like for instance meat and fish packages or cheese, bakery products, pizzas, sandwiches, and hamburgers packaging. Or the mentioned one layer barrier board can be made of over SR 50 ground chemical pulp in the same way as the second layer 2 of the three-layer barrier board 10. This product is suitable for instance packaging of the fresh foodstuffs like bakery products, cheeses, pizzas, sandwiches, and hamburgers. The storage times of these products packaged in one layer barrier board packages are shorter than in three-layer packages stored products because their barrier properties are weaker but their production costs are lower. The printing can be made to the surface of also these boards in some limits.

The barrier board 10 according to the aspects of the disclosed embodiments of two layers can be produced like the first layer 1 and the second layer 2 of the three-layer barrier board. The packaging technical properties of this product are almost the same level as the properties of the three-layer board, the production costs somewhat lower and the printing properties somewhere between the three-layer and one-layer board.

Next some constructions of some barrier boards 10 according to the aspects of the disclosed embodiments will be explained referring to the FIGS. 1-3.

One barrier board 10 of three layers for packaging foodstuffs has been described in FIG. 1. Its first layer 1 has been made mainly of ground hardwood pulp, softwood pulp, or a mixture of these chemical pulps the grinding SR value of which is over 50. In addition to that, the mentioned layer contains resin glue 1-4% of its weight and maximum 4% of carboxyl methyl cellulose (CMC) of its weight and the weight per sq m of this layer is over 50 g sq m. The second layer 2 consists mainly of softwood pulp, hardwood pulp, or a mixture of these chemical pulps the SR value of which is over 35. Additionally, this layer contains resin glue 1-4% of its weight and CMC maximum 4% of its weight and the weight of the layer is 100-170 g sq m. The surface layer that is at the second layer 2 side is called in this document the third layer 3 and it is made mainly of hardwood pulp the grinding SR value of which is <35 and its weight is 40-80 g sq m.

Another application of the aspects of the disclosed embodiments is a barrier board 10 similar to what has been presented above with the difference to former that the second layer 2 does not include resin glue or that the first layer 1 and the second layer 2 do not include resin glue.

The main barrier of the before described three-layer barrier board 10 is in its first layer 1 and the second layer 2 that mainly gives to the board good strength values includes a securing barrier. The third layer 3 includes favorable visual and printing properties. One application of the three-layer barrier board according to the invention is to set the SR value of the first layer 1 to the value of >35 and the value of the second layer 2 to the value of >50 so as far as these layers are concerned the other way around what has been stated before. With this construction, it is possible to secure in certain situations that the first layer 1 does not get too tight and that sufficiently moist comes through it to between the first layer 1 and the second layer 2 and thus there will not be formed so called blow that could separate the mentioned layers from each other.

One way to produce the two-layer or three-layer barrier board 10 is to form the second layer 2 of the mechanical pulp, CTMP, or semi-chemical pulp. The SR value of the first layer 1 can be set to the value of >50 even in that case and the second to >35 or vice versa.

In the FIG. 2 it has been described one two-layer barrier board 10 for packing foodstuffs. Its foodstuff side, the first layer 1, is made mainly of ground hardwood pulp, softwood pulp, or a mixture of these chemical pulps where the grinding SR value is over 50. Additionally, the mentioned layer has resin glue 1-4% of its weight and CMC maximum 4% of its weight and the weight of this layer is over 50 g sq m. The second layer 2 is made mainly of softwood pulp, hardwood pulp, or a mixture of these chemical pulps the SR value of which is over 35. Additionally, this layer contains resin glue 1-4% of its weight and CMC maximum 4% of its weight and its weight is 110-200 g sq m. The alternative is that the SR value of the first layer is set to the value of >35 and the second to the value of >50. The intention of this is to reach the same end result as the corresponding alternative in the three-layer barrier board.

The two-layer barrier board 10 can also be made so that its second layer 2 does not contain resin glue. Or then that its first and second layers 2 do not contain resin glue.

In FIG. 3 there has been shown one barrier board 10 for packing foodstuffs. It contains only the first layer 1 that is made mainly of hardwood pulp, softwood pulp, or a mixture of these chemical pulps the SR value of which is over 50. The weight of this layer is over 90 g sq m.

One application of the aspects of the disclosed embodiments is a one-layer barrier board that contains additionally resin glue 1-4% of its weight.

One one-layer application of the aspects of the disclosed embodiments is a similar to what has been presented before one-layer barrier board 10 with the difference that it additionally contains CMC maximum 4% of its weight.

One application of the aspects of the disclosed embodiments is a one-layer barrier board 10 differing from the two previous ones that it contains CMC maximum 4% of its weight but does not contain resin.

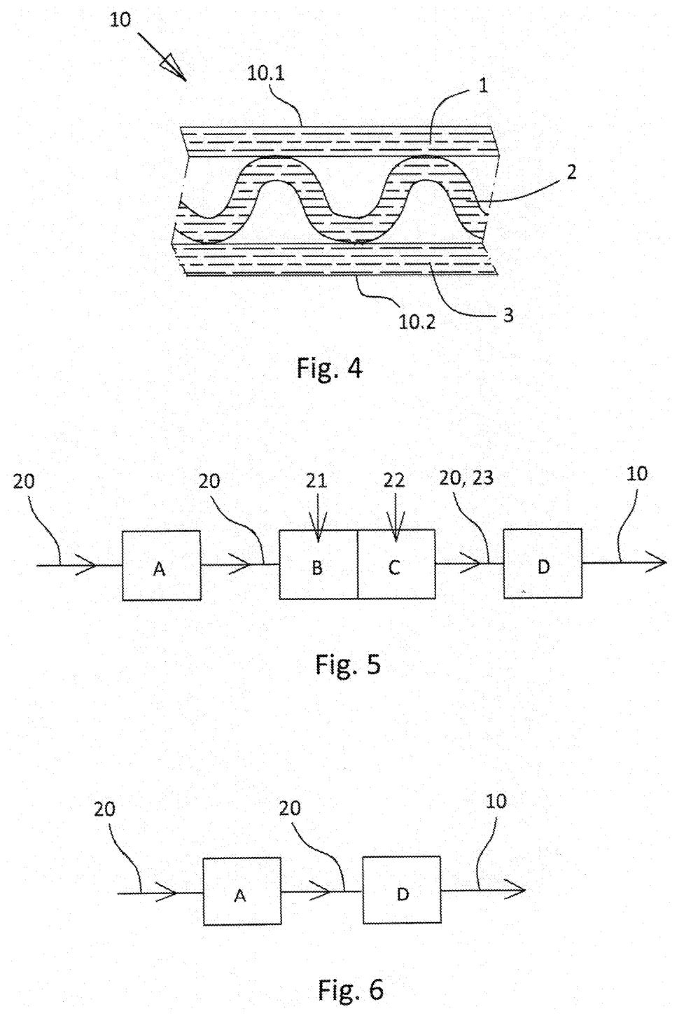

FIG. 4 shows an application of such a three-layer solution where the second layer 2 has been corrugated. The common name of the structure is a corrugated board. The main raw material of its all three layers is softwood pulp, hardwood pulp, or a mixture of these chemical pulps, SR value over 50 and the weight over 90 g sq m. In this barrier board 10 there is a barrier in every layer.

In another three-layer barrier board 10 corrugated board application the third layer 3 has been made of an ordinary white or brown surface kraftliner made for the corrugated board refining that is known to be a board with the SR value of <35 and weight 40-80 g sq m and a coating. By this way obtained third layer 3 weight is 100-150 g sq m. In this application of the aspects of the disclosed embodiments the first layer 1 and the second layer 2 are realized in the same way as in the previous application so that its barrier is in these two layers.

When realizing the corrugated board applications the second layer is fed through the corrugation unit of the board machine so that the desired corrugated shape is obtained.

FIG. 5 shows one application according to the aspects of the disclosed embodiments as a chart. It consists of the following actions: phase A; the chemical pulp 20 for each layer is ground with a grinder in such a way that the fiber bundles that form it get loose from each other fibrillate without the fibers essentially getting cut and that at least the grinding of the first layer chemical pulp has a mechanical influence on fibers without cutting them when the bonds between them remain also after the drying, Phases B and C; resin glue 21 is added to the chemical pulp 20 and/or CMC 22 if it or they are included into the construction in process, phase D; from the chemical pulps 20/the mixtures 23, the 1-, 2-, or 3-layer barrier board 10 is made using for this purpose adopted board or paper machine. The SR values of the chemical pulps and the amounts of the resin glue and CMC are adopted by layers as stated before being advantageous values and amounts.

FIG. 6 shows an application of the method according to the aspects of the disclosed embodiments where no resin or CMC is used. This application can be used in 1- to 3-layer barrier board 10 production and its barrier effect can be reached solely by grinding of the chemical pulp in phase A.

When the method according to the aspects of the disclosed embodiments is applied so that the back 10.1 and/or the surface 10.2 of the barrier board 10 is coated using with the CMC coating it can be done using the surface sizing unit of the paper/board machine or in a separate coating machine.

One way of realizing the method according to the aspects of the disclosed embodiments is to add to its back 10.1 a water soluble polymer dispersion layer.

One application of the aspects of the disclosed embodiments is to print in the surface 10.2 of the barrier board 10 an information conveying printing.

The surface 10.2 of the one-layer barrier board can be realized by for instance from so called kraftliner by laminating or gluing it on the outer surface of the layer.

One- or two-layer barrier boards 10 can also be produced in such a way that the first layer 1 or the first and the second layer 2 are made by laminating two or three layers together using CMC glue or wallpaper paste. This phase can be performed with a separate laminating machine.

Another way to compile the first layer 1 and the second layer 2 from three layers to combine is to laminate or glue them together using a corrugated board machine by bypassing the corrugation unit.

The before mentioned machines can also be utilized to combine the first, the second, and the third layer 1-3 when producing the barrier board according to the aspects of the disclosed embodiments.

The barrier board according to the aspects of the disclosed embodiments can also contain more than three layers.

The before mentioned different aspects of the disclosed embodiments applications can always be realized case by case in favorable combinations.

It should be noted that even though this explanation sticks to one type for the invention favorable realizing example this does by no means want to restrict the use of the invention for only this kind of usage, instead, many variations are possible in the scope of the inventive idea of the claims.

1-19. (canceled)

20. A barrier board made of ordinary chemical pulp where a length of fibers is about 500-3000 μm and a diameter 15-40 μm and where there is at least a first layer and a second layer and the barrier board is intended for foodstuff packaging against water, oil and/or fat wherein:
a. a main raw material of the first layer is softwood pulp, hardwood pulp, or a mixture of these chemical pulps and a grinding SR value of which is over 50,
b. a main raw material of the second layer is softwood pulp, hardwood pulp, or a mixture of these chemical pulps, mechanical pulp, CTMP mass, or semi-chemical pulp and when the main raw material of the second layer is one of the three first mentioned its SR value is over 35, or
c. when the before mentioned raw material condition is fulfilled grinding values of the first layer and the second layer are the other way around than what has been defined before.

21. The barrier board in accordance with claim 20 wherein it consists of two layers and a weight of the second layer is 110-200 g sq m.

22. The barrier board in accordance with claim 20 wherein it contains a third layer beside the second layer, a raw material of which is softwood pulp, hardwood pulp, or a mixture of these chemical pulps.

23. The barrier board in accordance with claim 22 wherein a grinding SR value of the third layer is under 35.

24. The barrier board in accordance with claim 20 wherein a weight of the first layer is over 50 g sq m.

25. The barrier board in accordance with claim 20 wherein a weight of the second layer is over 100-170 g sq m.

26. The barrier board in accordance with claim 22 wherein a weight of the third layer is 40-80 g sq m.

27. A barrier board made of ordinary chemical pulp, a length of fibers of which is about 500-3000 μm and a diameter 15-40 μm, and where there are two or three layers and the barrier board is intended for packaging foodstuffs against water, oil and/or fat wherein:
a. a main raw material of a first layer and a second layer is softwood pulp, hardwood pulp or a mixture of these chemical pulps, a grinding SR value of which is over 50, and
b. the second layer is corrugated so that the barrier board is a corrugated board.

28. The barrier board in accordance with claim 27 wherein the second layer contains resin glue 1-4% of its weight and/or CMC (maximum 4% of its weight).

29. The barrier board in accordance with claim 27 wherein a grinding SR value of a third layer is over 50.

30. The barrier board in accordance with claim 27, wherein it consists of white or brown surface kraftliner that consists of board that has a grinding SR value under 35 and to its surface attached coating.

31. The barrier board in accordance with claim 27 wherein a weight per square meter of all layers is over 90 g sq m.

32. A barrier board made of ordinary chemical pulp, a length of fibers of which is about 500-3000 μm and a diameter 15-40 μm and contains one layer that is a first layer, and is intended for foodstuff packaging against water, oil and/or fat wherein a main raw material of the first layer is softwood pulp, hardwood pulp or a mixture of these chemical pulps, a grinding SR value of which is over 50 and a weight per square meter of the first layer is over 90 g.

33. The barrier board in accordance with claim 32 further comprising a second layer, wherein the first layer and/or the second layer contain(s) resin glue 1-4% of its weight and/or CMC maximum 4% of its weight.

34. The barrier board in accordance with claim 32 wherein to its back a CMC coating and/or water soluble polymer dispersion coating has been adapted.

35. The barrier board in accordance with claim 32 wherein at least one of its layers contains at least two layer-like to each other attached parts.
